(19) United States
(12) Patent Application Publication
(10) Pub. No.: US 2015/0241224 A1
(43) Pub. Date: Aug. 27, 2015

(54) SYSTEM AND METHOD FOR ENABLING POINT OF INTEREST INFORMATION TO A NAVIGATION SYSTEM

(71) Applicant: FORD GLOBAL TECHNOLOGIES, LLC, Dearborn, MI (US)

(72) Inventors: Philip Joseph DANNE, Royal Oak, MI (US); Joey Ray GROVER, Madison Heights, MI (US); Joel J. FISCHER, Royal Oak, MI (US)

(73) Assignee: FORD GLOBAL TECHNOLOGIES, LLC, Dearborn, MI (US)

(21) Appl. No.: 14/188,987

(22) Filed: Feb. 25, 2014

(51) Int. Cl. G01C 21/34

(52) U.S. Cl. CPC G01C 21/34

(57) ABSTRACT

A point-of-interest information system comprising a transceiver configured to send and receive data and a processor in communication with the transceiver. The processor configured to receive at least a portion of point-of-interest (POI) data from a nomadic device using the transceiver. The at least a portion of the received POI data is in a first format that is incompatible with a vehicle navigation system. The processor may reformat the at least a portion of the POI data from the first format to a second format compatible with a navigation system according to an application programming interface. The processor may transmit the portion of the POI data to the navigation system.

### TECHNICAL FIELD

The present disclosure generally relates to a mobile application connectivity service and, more particularly, to a vehicle computing system configured to receive data from a mobile device and transmit the information to a navigation system.

### BACKGROUND

U.S. Pat. No. 8,621,374 generally discloses a method and apparatus for sending and retrieving location relevant information to a user by selecting and designating a point of interest that is displayed on a graphical user interface and sending the location information associated with that point of interest to a receiver that is also selected using the graphical user interface. The location relevant information may also include mapped routes, waypoints, geo-fenced areas, moving vehicles etc. Updated location relevant information may also be continuously sent to the user while generating updated mapping information on the graphical user interface. The disclosure may be practiced by using communication devices such as a personal computer, a personal digital assistance, in-vehicle navigation systems, or a mobile telephone.

U.S. Patent Application 2014/0012497 generally discloses a vehicle navigation system and method for presenting information originating from a mobile device on a vehicle navigation system display of a vehicle. A method of presenting information originating from a mobile device on a vehicle navigation system display of a vehicle includes receiving, by a vehicle navigation system, application data from an application operating on the mobile device, wherein the application data from the application represents an entity in proximity to the vehicle. The method further includes displaying an icon representing the application data from the application on a map presented on the vehicle navigation system display. The icon is positioned on the map according to a geographic location of the entity.

### SUMMARY

In a first illustrative embodiment, a point-of-interest information system comprising a transceiver configured to send and receive data and a processor in communication with the transceiver. The processor configured to receive at least a portion of point-of-interest (POI) data from a nomadic device using the transceiver. The portion of received POI data is in a first format that is incompatible with a vehicle navigation system. The processor may reformat at least a portion of the POI data from the first format to a second format compatible with a navigation system according to an application programming interface. The processor may transmit the portion of the POI data to the navigation system.

In a second illustrative embodiment, a non-transitory computer-readable medium storing computer executable instructions that, when executed by one or more processors, cause a vehicle computing system to receive at least a portion of geographic location data from a nomadic device. The geographic location data is indicative of a point-of-interest. The computer-readable medium may store additional instructions to parse the at least a portion of geographic location data based on a first format. The computer-readable medium may store additional instructions to reformat the parsed data from the first format to a second format according to an application programming interface of a navigation system. The computer-readable medium may store additional instructions to transmit the at least a portion of the point-of-interest to the navigation system.

In a third illustrative embodiment, a point-of-interest (POI) information system comprising at least one processor communicating with a transceiver. The processor is configured to transmit one or more items to a vehicle computing. The processor is further configured to receive a request for at least a portion of POI data based on a selected item from the vehicle computer. The processor is further configured to format the at least a portion of POI data in a first format and transmit the at least a portion of POI data to the vehicle computer.

### BRIEF DESCRIPTION OF THE DRAWINGS

FIG. 1 is an exemplary block topology of a vehicle infotainment system implementing a user-interactive vehicle information display system according to an embodiment;

FIG. 2 is an exemplary block topology of a system for integrating one or more connected devices with the vehicle based computing system according to an embodiment;

FIG. 3 is an exemplary block topology of a vehicle computing system receiving point of interest data transmitted from a connected mobile device according to an embodiment;

FIG. 4 is an exemplary block topology of a vehicle navigation system receiving point of interest data transmitted from a connected nomadic device according to an embodiment;

FIG. 5 is a flow chart illustrating an example method of formatting point of interest data received from one or more data sources and transmitting the point of interest data to a vehicle computing system according to an embodiment; and

FIG. 6 is a flow chart illustrating a process of a navigation system receiving and displaying point of interest data according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programmed to perform any number of the functions as disclosed.

A navigation system that is pre-installed in a vehicle computing system may be difficult to update with data that is of interest to a user. The data may include, but is not limited to, point of interest data. The point of interest data (herein known as POI data) is quickly-changing data, for example, reviews and/or recommendations of a new restaurant in town may be frequently changing or if a hotel has any open vacancies. Some pre-installed navigation systems may download POI data in large batches on a periodic base, which may be rarely updated (e.g., updated once a year). Other navigation systems may update POI data from a specific, pre-determined data source such as a web server or a mobile device application that is used to manage the data updates.

The present disclosure provides a system and method that may transmit POI data to the navigation system from one or more mobile devices. The system may communicate with multiple independent data source including, but not limited to, web servers and/or mobile device applications. The system may communicate with one or more web servers, a nomadic device and/or mobile device applications based on a common descriptive language known by the system and all data sources, however the common descriptive language may not be known to the navigation system. The system may reformat the POI data received from the web server, nomadic device, and/or mobile device applications. The system may communicate the reformatted POI data to the navigation system using the navigation system application programming interface (API).

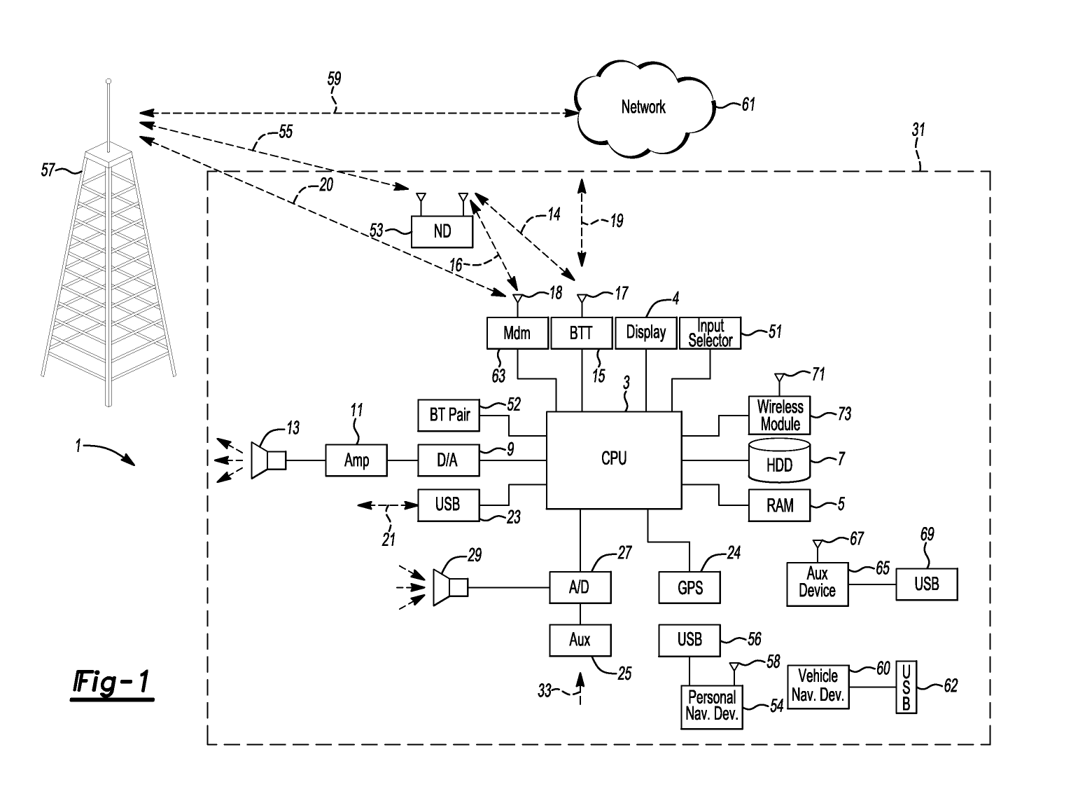

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smartphone, tablet, laptop, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

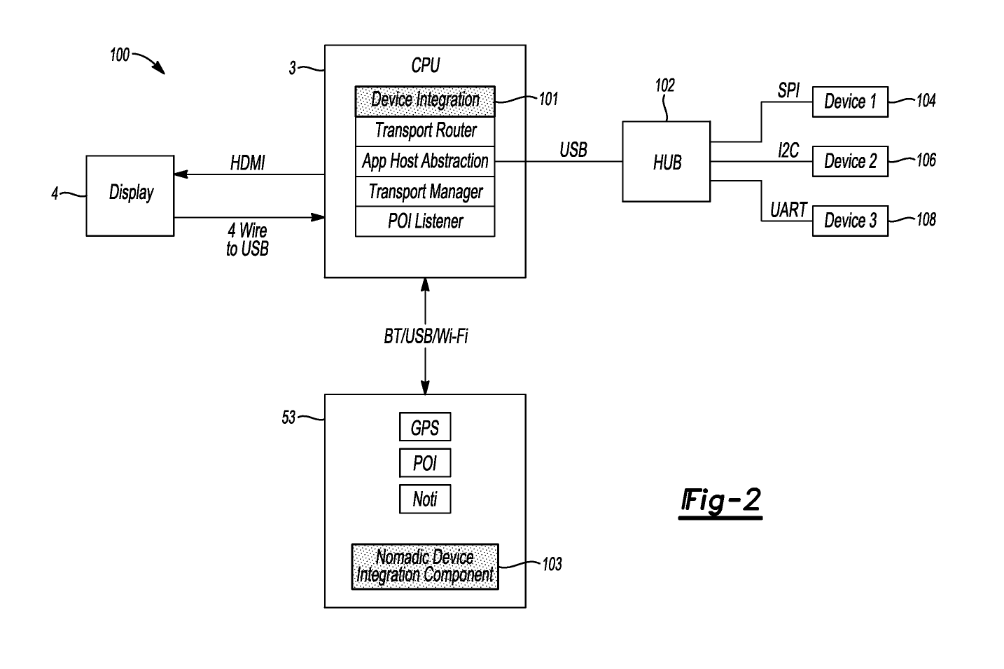

FIG. 2 is an exemplary block topology of a system 100 for integrating one or more connected devices with the vehicle based computing system 1 (VCS) according to one embodiment. The CPU 3 may be in communication with one or more transceivers. The one or more transceivers are capable for wired and wireless communication for the integration of one or more devices. To facilitate the integration, the CPU 3 may include a device integration framework 101 configured to provide various services to the connected devices. These services may include transport routing of messages between the connected devices and the CPU 3, global notification services to allow connected devices to provide alerts to the user, application launch and management facilities to allow for unified access to applications executed by the CPU 3 and those executed by the connected devices, and point of interest location and management services for various possible vehicle 31 destinations.

As mentioned above, the CPU 3 of the VCS 1 may be configured to interface with one or more nomadic devices 53 of various types. The nomadic device 53 may further include a device integration client component 103 to allow the nomadic device 53 to take advantage of the services provided by the device integration framework 101.

The one or more transceivers may include a multiport connector hub 102. The multiport connector hub 102 may be used to interface between the CPU 3 and additional types of connected devices other than the nomadic devices 53. The multiport connector hub 102 may communicate with the CPU 3 over various buses and protocols, such as via USB, and may further communicate with the connected devices using various other connection buses and protocols, such as Serial Peripheral Interface Bus (SPI), Inter-integrated circuit (I2C), and/or Universal Asynchronous Receiver/Transmitter (UART). The multiport connector hub 102 may further perform communication protocol translation and interworking services between the protocols used by the connected devices and the protocol used between the multiport connector hub 102 and the CPU 3. The connected devices may include, as some non-limiting examples, a radar detector 104, a global position receiver device 106, and a storage device 108.

The VCS 1 may receive at least a portion of data from one or more connected devices and format the at least a portion of data for output to one or more user interfaces. The one or more user interfaces may include, but is not limited to, a display 4 (e.g., touchscreen), speakers and/or an instrument cluster and gages. In one example, the display may allow for user input using soft keys on the touchscreen, interaction with knobs and switches, and/or voice commands. The display configuration may include, but is not limited to, an HDMI (four-wire) connection between the CPU 3 and the touchscreen display 4.

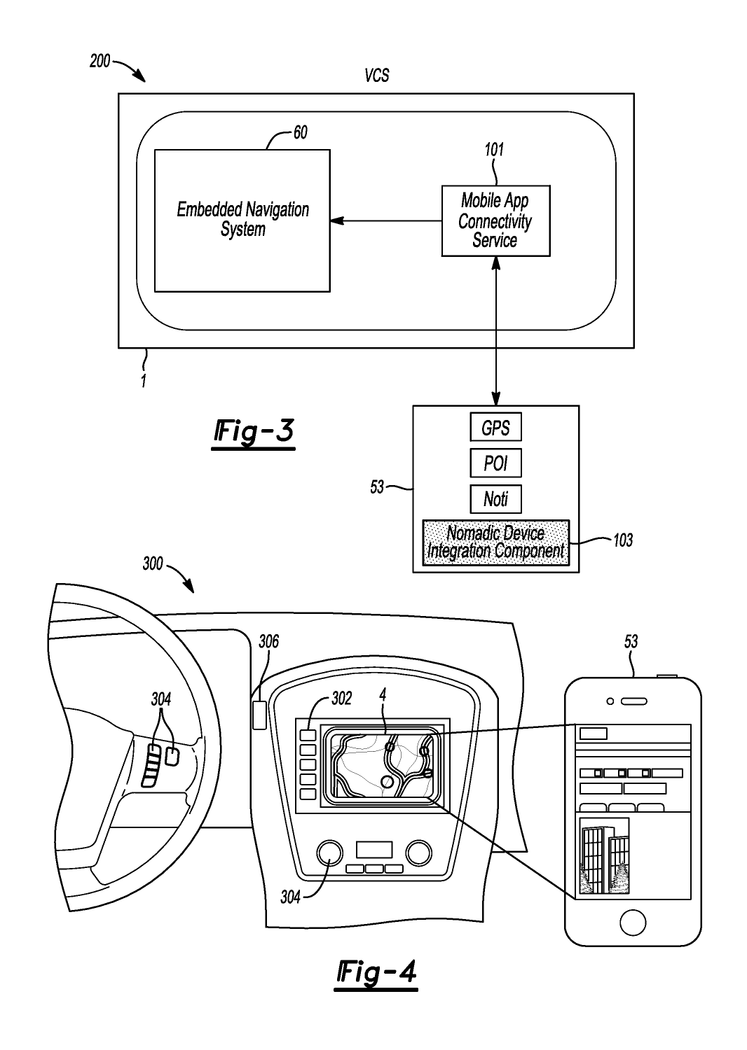

FIG. 3 is an exemplary block topology of a vehicle system 200 having an embedded navigation system receiving point of interest data transmitted from a connected nomadic device according to an embodiment. The system may include the VCS 1 having the device integration framework 101 configured to provide mobile application connectivity service that receives POI location and management services for various possible vehicle 31 destinations. The VCS 1 may have an embedded navigation system 60 for providing visual output such as, for example, maps, navigation, entertainment, information, or combinations thereof. The VCS 1 may have a display 4 that may present information received from the navigation system 60. The display may include any medium capable of transmitting an optical output such as, for example, a cathode ray tube, light emitting diodes, a liquid crystal display, a plasma display, or the like. Moreover the display 4 in communication with the VCS 1 may be a touch screen that, in addition to providing optical information, detects the presence and location of a tactile input upon a surface of or adjacent to the display 4.

The POI location and management services may receive at least a portion of data streaming on a nomadic device. The data streaming on the nomadic device may be associated with, and operated by, an organization that provides the respective data. The nomadic device may be streaming data from one or more organizations, such that the nomadic device may be commutatively coupled to any number of servers by way of the cellular network.

For example, the nomadic device may be steaming data from the Yelp website stored on a server that is in communication with the nomadic device by way of the cellular network. The nomadic device may be streaming data from Yelp and may transmit the data received from the Yelp website or Yelp application to the VCS 1. The data may be in no particular format that is related to the navigation system 60 and/or the VCS 1; therefore the VCS 1 may receive the data and translate it to a particular format that may be communicated to the navigation system 60.

The POI location and management services may receive the Yelp data from the nomadic device and translate the data such that is may be communicated to the navigation system via the navigation system application programming interface (API). The POI location and management service may receive data that is formatted in several forms and parse the data such that the service may properly format the data for transmittal and display at the navigation system. The navigation system 60 may then receive the formatted data directly from the POI location and management service being executed with hardware on the VCS 1. The navigation system 60 may output the received formatted data at the display 4 of the VCS 1.

For example, a user may want to update their navigation information with a POI that is generated from their favorite websites, social media site, or mobile phone applications. The POI data may also include “crowd sourced” review and/or rating applications, for example OpenTable, Yelp, Foursquare, etc. . . . ). The POI information/data may be sent to the VCS 1 through a nomadic device communicating with the system. In one embodiment, the nomadic device may format the POI information/data to a format before being transmitted to the VCS. The format, herein known as a first format, may be a common descriptive language known by the VCS 1. The POI location and management service 101 may reformat the data from the first format to a second format based on the API format of the navigation system.

The POI location and management service enables application data that the user desires to have displayed on the vehicle navigation system without requiring the application data to be formatted and/or configured based on the navigation system and/or API configuration. The nomadic device 53 may communicate with the VCS and transmit the data from one or more websites or applications. The VCS 1 may receive the application data and administer the POI location and management service to parse, interpret, translate, and/or format the data for communication to the navigation system.

FIG. 4 is an exemplary block topology of a vehicle navigation system receiving point of interest data transmitted from a connected nomadic device according to an embodiment. The VCS 1 is configured to communicate with the nomadic device 53 to receive data from various websites and/or applications that are stored or are otherwise running on the nomadic device 53. The data received from the nomadic device 53 may be indicative of one or more entities and the geographic location of those one or more entities. The navigation system may receive the data from the nomadic device by having the POI location and management service perform at least one of translating, parsing, and formatting of the data. The POI location and management service may process the data and interpret the geographic location of one or more entities, and configure the data in a format that may be transmitted to the navigation system. The data may be formatted based on the API of the navigation system.

For example, the nomadic device 53 may communicate restaurant information from OpenTable to be presented by the navigation system display 4 of the VCS 1. The VCS 1 may receive the OpenTable data from the nomadic device and translate the information using the POI location and management service. The OpenTable data may not be required to be in a format known by the navigation system before being transmitted to the VCS 1 from the nomadic device. The POI location and management service may receive at least a portion of the data, and format at least a portion of the data such that it may be interpreted by the navigation system for display.

The VCS 1 may comprise input hardware such that the one or more processers communicating within the system are capable of receiving instructions from a user. The input hardware may include any device capable of transforming mechanical, optical, or electrical signals into a data signal capable of being transmitted to the VCS 1. The input hardware may include any number of movable objects that transform physical motion into a data signal that can be transmitted over to the VCS 1, for example, a button 302, a switch 304, a knob 304, a microphone 306 or the like.

A user may command information from the nomadic device using the input hardware.
The user may operate the VCS and/or navigation system by providing motion to the movable objects of the input hardware (e.g., the button 302, the switch 304, and/or the knob 304) and/or using voice commands received by the microphone 306. In response to the received input from the user, the transferred motion of the input hardware and/or voice commands are transformed into a data signal that can be transmitted over the vehicle network. The data signals may request point of interest information from the nomadic device 53. The nomadic device 53 may transmit third party information regarding point of interest data including, but not limited to, geographic location within the proximity of the vehicle.

For example, the user may request POI information regarding a restaurant from OpenTable. The nomadic device 53 may transmit the restaurant data from OpenTable including, but not limited to, an address, cuisine, menu, and/or reviews. The OpenTable data may be in a format that is unfamiliar with the VCS 1 and/or navigation system 60. The VCS 1 may have a POI location and management service that may interrupt and interpret the data received from OpenTable, and convert the data using the navigation system API. The converted data may be transmitted to the navigation system 60 for display. The navigation system 60 may present the location of the restaurant using a map at the display 4. The map may display various roads associated with the geographic location within the proximity of the vehicle and the location of the restaurant requested by the user. The size of the area displayed on the map (i.e., the scale) may be user-selectable using one or more inputs including, but not limited to, touch screen soft-keys on the display 4. The geographic information displayed by the map may be based at least in part on information provided by a satellite module in communication with the navigation system 60, VCS 1, and/or nomadic device 53.

There may be multiple applications and/or websites running on the nomadic device 53 that may provide data to the vehicle navigation system 60. The multiple applications and/or websites may not rely upon a third party and/or OEM aggregator, instead the applications and/or websites may communicate with the VCS 1 directly with a common descriptive language. The applications and/or websites running on the nomadic device 53 may update POI based on a current location of the vehicle. The nomadic device 53 and/or VCS 1 may receive geographic location data regarding proximity of the vehicle, and request for POI data from the one or more applications/websites. For example, the nomadic device 53 may have the Gas Buddy application and/or website running on the device, the Gas Buddy application and/or website may send data that corresponds to any number of close-by gas stations based on the vehicle location. In another example, OpenTable may send data that corresponds to any number of close-by restaurants based on the vehicle location. The data received from the one or more application and/or websites may be in a common language format and translated by the POI location and management service before being transmitted to the navigation system 60 for display.

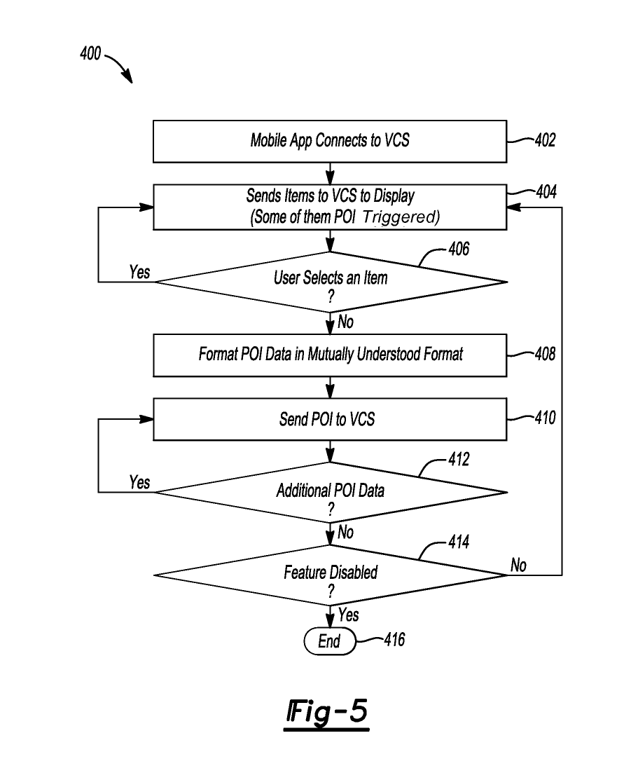

FIG. 5 is a flow chart illustrating an example method of a nomadic device receiving point of interest data from one or more data sources and transmitting the data to a vehicle computing system. The nomadic device 53 may connect to a VCS of a vehicle using wired or wireless technology. The wired technology includes, but is not limited to, USB, SPI, and/or UART. The wireless technology includes, but is not limited to, Bluetooth, Bluetooth low energy, WiFi, and/or MiFi. The VCS may communicate with one or more nomadic devices using wired and/or wireless technology.

At step 402, the nomadic device may have one or more mobile applications that connect to the VCS. The mobile application may send one or more items to the VCS for display including, but not limited to, POI item(s) at step 404.

At step 406, the nomadic device may receive input that a user has selected an item based on the one or more mobile applications. If the user selects an item, the mobile device may format the POI data in a mutually understood format at step 408. If the user does not select an item, the mobile device may continue to transmit to the VCS one or more items in response to the one or more applications and/or website services being executed at the nomadic device.

At step 410, once the POI data has been formatted, the nomadic device 53 may send the POI data to the VCS. The nomadic device 53 may continuously transmit POI data to the VCS at step 412.

At step 414, the nomadic device may determine if the one or more applications have been disable. If the one or more applications are disabled, the nomadic device may discontinue communication of data to the VCS at step 416. If the one or more applications are still enabled, the nomadic device may continue to send items to the VCS display.

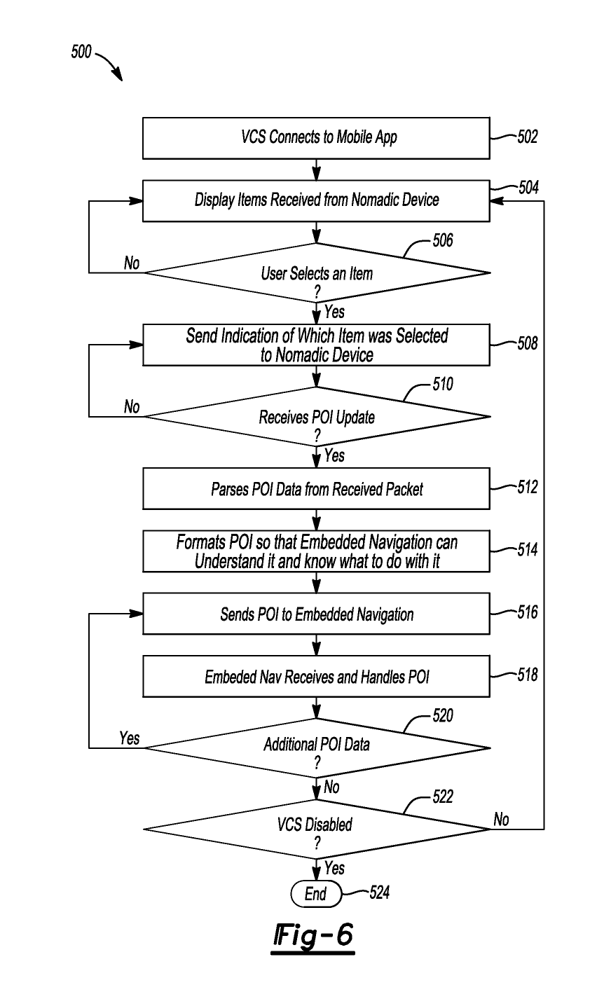

FIG. 6 is a flow chart illustrating a method of a navigation system receiving and displaying point of interest data according to an embodiment. The method is implemented using software code contained within the VCS 1 having one or more processors and executed by the hardware contained within the VCS 1, according to one or more embodiments. In other embodiments, the method 500 is implemented in other vehicle controllers, or distributed amongst multiple vehicle controllers and/or processors located at the nomadic device.

Referring again to FIG. 6, the vehicle and its components illustrated in FIG. 1, FIG. 2, FIG. 3, and FIG. 4 are referenced throughout the discussion of the method to facilitate understanding of various aspects of the present disclosure. The method of receiving point of interest data from one or more application being communicated by at least one nomadic device may be implemented through a computer algorithm, machine executable code, or software instructions programmed into a suitable programmable logic device(s) of the vehicle, such as the vehicle control module, the VCS control module, another controller in communication with the vehicle computing system, or a combination thereof. Although the various steps shown in the flowchart diagram 500 appear to occur in a chronological sequence, at least some of the steps may occur in a different order, and some steps may be performed concurrently or not at all.

At step 502, the VCS 1 recognizes one or more mobile device applications from at least one nomadic device 53. The VCS 1 may connect with the one or more mobile device applications using wired or wireless technology with the at least one nomadic device 53. The VCS 1 may output to a display 4 one or more items received from the nomadic device 53 at step 504.

At step 506, the VCS 1 may receive input from a user requesting additional information by selecting one or more items being displayed. The user may select an item by using the input hardware including, but not limited to, touch screen soft keys, voice commands received by the microphone, knobs, and/or steering wheel controls. The VCS 1 may transmit an indication of which item was selected to the nomadic device 53 at step 508.

In another embodiment, the VCS 1 may request for data from one or more connected nomadic devices based on the vehicle's current geographical location. The VCS 1 may recognize one or more applications being run on a connected device and request items and their associated POI data based on the vehicle's location.

At step 510, the VCS 1 may receive a POI update from the nomadic device 53 based on the selected item. If the VCS 1 does not receive additional information from the nomadic device 53 based on the selected item, the VCS may continue to send a request for the additional information.

At step 512, the VCS may parse the POI data from the packet of data received by the nomadic device 53 based on the selected item. The VCS may format the POI data so that the embedded navigation system may understand it and know what to do with the POI data at step 514.

For example, the VCS may receive the POI data in a first format not compatible with the navigation system. The VCS may reformat the POI data from the first format to the second format that is based on the application programming interface of the navigation system.

At step 516, the VCS may transmit the POI data to the embedded navigation system. The embedded navigation system may receive and process the POI data at step 518. The navigation system may process the POI data such that it updates its display to include information related to the POI. For example, the POI data may include a business address; therefore the navigation system may update the display to include the business address.

At step 520, the embedded navigation system may continuously update its display based on POI data received from the VCS 1. If no additional POI data is received, the navigation system may determine if the VCS is being requested to disable at step 522. If the system is not being requested off, the VCS may continue to display the one or more items received from the nomadic device. If a key-off event is detected by the VCS, the system may end the one or more algorithms used to manage the POI communication to the navigation system. The VCS may have a vehicle key-off mode to allow the system to store one or more parameters in nonvolatile memory such that the POI data may be used by the system for the next key-on event at step 524.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

1. A point-of-interest information (POI) system comprising:
a vehicle processor in communication with a transceiver and configured to:
transmit a geographic location to a nomadic device using the transceiver;
receive at least a portion of incompatible POI data from the nomadic device;
parse the at least a portion of the incompatible POI data from a first format;
configure the parsed incompatible POI data to a second format compatible with a navigation system according to an application programming interface; and
transmit the second format POI data to the navigation system.

2. The system of claim 1, wherein the first format enables the processor to communicate with one or more websites and mobile applications.

3. The system of claim 1, wherein the at least portion of incompatible POI data includes an address of a business location.

4. The system of claim 1, wherein the at least portion of incompatible POI data includes a name of a business.

5. The system of claim 1, wherein the nomadic device is at least one of a smartphone, tablet, and laptop.

6. The system of claim 1, wherein the transceiver is at least one of wired and wireless technology.

7. The system of claim 1, wherein the navigation system is embedded within a vehicle computing system.

8. A non-transitory computer-readable medium storing computer executable instructions that, when executed by one or more processors, cause a vehicle computing system to:
transmit a geographic location to a nomadic device using the transceiver;
receive at least a portion of incompatible data from the nomadic device based on the geographic location;
parse the at least a portion of incompatible data based on a first format;
configure the parsed incompatible data to a second format compatible with a vehicle navigation system according to an application programming interface; and
transmit the at least a portion of the second format data to the navigation system.

9. The non-transitory computer-readable medium of claim 8, wherein the first format enables the vehicle computing system to communicate with one or more websites and mobile applications.

10. The non-transitory computer-readable medium of claim 8, wherein the at least portion of incompatible data includes an address of a business location.

11. The non-transitory computer-readable medium of claim 8, wherein the at least portion of incompatible data includes a name of a business.

12. The non-transitory computer-readable medium of claim 8, wherein the navigation system has a touch screen display.

13. The non-transitory computer-readable medium of claim 8, wherein the one or more processors are in communication with a transceiver to receive incompatible data from the nomadic device using at least one of wired and wireless technology.

14. The non-transitory computer-readable medium of claim 8, wherein the navigation system is embedded within a vehicle computing system.

15. A vehicle system comprising:
a processor in communication with a transceiver and configured to:
transmit a geographic location to a nomadic device;
receive application data in several formats from the nomadic device based on the geographic location;
parse POI data from the application data in a first format;
configure the parsed POI data in a second format compatible with a vehicle navigation system; and
transmit the second format POI data to the vehicle navigation system.

16. The vehicle system of claim 15, wherein the processor is further configured to configure the parsed POI data in the second format according to the vehicle navigation system application programming interface.

17. (canceled)

18. The vehicle system of claim 15, wherein in response to the second format, the vehicle navigation system outputs the at least a portion of the compatible POI data to a display.

19. The vehicle system of claim 15, wherein the at least one processor communicating with the transceiver is embedded on a nomadic device.

20. The vehicle system of claim 15, wherein the application data is based on at least one of a mobile application and a website.
